(19) United States
(12) Patent Application Publication
(10) Pub. No.: US 2025/0080188 A1
(43) Pub. Date: Mar. 6, 2025

(54) Machine Learning Based CSI Feedback Acquisition

(71) Applicant: Nokia Technologies Oy, Espoo (FI)

(72) Inventor: Xiaomao MAO, Massy (FR)

(21) Appl. No.: 18/811,841

(22) Filed: Aug. 22, 2024

(30) Foreign Application Priority Data
Sep. 1, 2023 (WO) PCT/FI2023/050499

(51) Int. Cl. H04B 7/06; H04L 25/02; H04W 24/02

(52) U.S. Cl. CPC H04B 7/0626; H04L 25/0202; H04W 24/02

(57) ABSTRACT

There is provided an apparatus, and corresponding method, configured to perform operations comprising: indicating, to a network node of a cellular communication network, capability to support machine learning, ML, based channel state information, CSI, feedback acquisition; receiving, from the network node, an indication to use the ML based CSI feedback acquisition; obtaining a CSI-reference signal, CSI-RS, pattern and a CSI feedback size threshold, wherein the CSI-RS pattern and the CSI feedback size threshold are determined jointly; receiving one or more pilot signals for at least one channel according to the CSI-RS pattern; inputting a result of at least one measured channel on the one or more pilot signals into an ML model and obtaining CSI feedback as an output from the ML model; and transmitting, to the network node, the CSI feedback according to the CSI feedback size threshold.

### TECHNICAL FIELD

Various example embodiments relate generally to cellular communications. More particularly, the various examples relate to machine learning (ML) based channel state information (CSI) feedback acquisition.

### BACKGROUND

CSI feedback acquisition, and especially Type II CSI feedback acquisition, may create problems, for example, in terms of increased overhead. ML has been proposed for performing at least some tasks related to CSI feedback acquisition. However, there still seems to be room for improving the CSI feedback acquisition using ML based procedure.

### BRIEF DESCRIPTION

According to some aspects, there is provided the subject matter of the independent claims. Some further aspects are defined in the dependent claims. The embodiments that do not fall under the scope of the claims are to be interpreted as examples useful for understanding the disclosure.

### LIST OF THE DRAWINGS

In the following, the invention will be described in greater detail with reference to the embodiments and the accompanying drawings, in which

FIG. 1 presents a network to which one or more embodiments are applicable;

FIG. 2 illustrates a two-step CSI feedback procedure;

FIGS. 3 and 4 illustrate flow diagrams according to some embodiments;

FIG. 5 illustrates signaling diagram according to some embodiments;

FIGS. 6 and 7 illustrate some examples; and

FIGS. 8 and 9 illustrate apparatuses according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C). A(s) may refer to one or more A and similarly B(s) may refer to one or more B as used herein.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments.

Embodiments described may be implemented in a radio system, such as one comprising at least one of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE). Term ‘eLTE’ here denotes the LTE evolution that connects to a 5G core. LTE is also known as evolved UMTS terrestrial radio access (EUTRA) or as evolved UMTS terrestrial radio access network (EUTRAN). A term “resource” may refer to radio resources, such as a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources

The embodiments are not, however, restricted to the systems/RATs given as an example but a person skilled in the art may apply the solution to other communication systems/networks provided with necessary properties. Some examples of a suitable communication networks include a 5G network and/or a 6G network. The 3GPP solution to 5G is referred to as New Radio (NR). 6G is envisaged to be a further development of 5G. NR may enable the use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G may require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customized to meet the specific needs of applications, services, devices, customers or operators.

In radio communications, node operations may in be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of work between core network operations and base station operations may vary depending on implementation. 5G and beyond network architecture may be based, but not necessarily, on a so-called CU-DU split. One gNB-CU controls several gNB-DUs. The term ‘gNB’ may correspond in 5G to the eNB in LTE. The gNBs (one or more) may communicate with one or more UEs. The gNB-CU (central node) may control a plurality of spatially separated gNB-DUs, acting at least as transmit/receive (Tx/Rx) nodes. In some embodiments, however, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI model and the functionalities within each layer.

In an embodiment, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Some other possible technology advancements to be used are Software-Defined Networking (SDN), Big Data, and all-IP, to mention only a few non-limiting examples. For example, network slicing may be a form of virtual network architecture using the same principles behind software defined networking (SDN) and network functions virtualisation (NFV) in fixed networks. SDN and NFV may deliver greater network flexibility by allowing traditional network architectures to be partitioned into virtual elements that can be linked (also through software). Network slicing allows multiple virtual networks to be created on top of a common shared physical infrastructure. The virtual networks are then customised to meet the specific needs of applications, services, devices, customers or operators.

The plurality of gNBs (access points/nodes), each comprising the CU and one or more DUs, may be connected to each other via the Xn interface over which the gNBs may negotiate. The gNBs may also be connected over next generation (NG) interfaces to a 5G core network (5GC), which may be a 5G equivalent for the core network of LTE. Such 5G CU-DU split architecture may be implemented using cloud/server so that the CU having higher layers locates in the cloud and the DU is closer to or comprises actual radio and antenna unit. There are similar plans ongoing for LTE/LTE-A/eLTE as well. When both eLTE and 5G will use similar architecture in a same cloud hardware (HW), the next step may be to combine software (SW) so that one common SW controls both radio access networks/technologies (RAN/RAT). This may allow then new ways to control radio resources of both RANs. Furthermore, it may be possible to have configurations where the full protocol stack is controlled by the same HW and handled by the same radio unit as the CU.

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future rail-way/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The embodiments may be also applicable to narrow-band (NB) Internet-of-things (IoT) systems which may enable a wide range of devices and services to be connected using cellular telecommunications bands. NB-IoT is a narrowband radio technology designed for the Internet of Things (IoT) and is one of technologies standardized by the 3rd Generation Partnership Project (3GPP). Other 3GPP IoT technologies also suitable to implement the embodiments include machine type communication (MTC) and eMTC (enhanced Machine-Type Communication). NB-IoT focuses specifically on low cost, long battery life, and enabling a large number of connected devices. The NB-IoT technology is deployed “in-band” in spectrum allocated to Long Term Evolution (LTE)—using resource blocks within a normal LTE carrier, or in the unused resource blocks within a LTE carrier's guard-band—or “standalone” for deployments in dedicated spectrum.

The embodiments may be also applicable to device-to-device (D2D), machine-to-machine, peer-to-peer (P2P) communications. The embodiments may be also applicable to vehicle-to-vehicle (V2V), vehicle-to-infrastructure (V2I), infrastructure-to-vehicle (12V), or in general to V2X or X2V communications.

FIG. 1 illustrates an example of a communication system to which embodiments of the invention may be applied. The system may comprise a control node 110 providing one or more cells, such as cell 100, and a control node 112 providing one or more other cells, such as cell 102. Each cell may be, e.g., a macro cell, a micro cell, femto, or a pico cell, for example. In another point of view, the cell may define a coverage area or a service area of the corresponding access node. The control node 110, 112 may be an evolved Node B (eNB) as in the LTE and LTE-A, ng-eNB as in eLTE, gNB of 5G, or any other apparatus capable of controlling radio communication and managing radio resources within a cell. The control node 110, 112 may be called a base station, network node, or an access node.

The system may be a cellular communication system composed of a radio access network of access nodes, each controlling a respective cell or cells. The access node 110 may provide user equipment (UE) 120 (one or more UEs) with wireless access to other networks such as the Internet. The wireless access may comprise downlink (DL) communication from the control node to the UE 120 and uplink (UL) communication from the UE 120 to the control node.

Additionally, although not shown, one or more local area access nodes may be arranged such that a cell provided by the local area access node at least partially overlaps the cell of the access node 110 and/or 112. The local area access node may provide wireless access within a sub-cell. Examples of the sub-cell may include a micro, pico and/or femto cell. Typically, the sub-cell provides a hot spot within a macro cell. The operation of the local area access node may be controlled by an access node under whose control area the sub-cell is provided. In general, the control node for the small cell may be likewise called a base station, network node, or an access node.

There may be one or more UEs 120, 122 in the system. UE(s) 120, 122 may be served by one or more control nodes 110, 112. The UE(s) 120, 122 may communicate with each other, for example, using D2D communication interface established between them. D2D communication may refer to, for example, sidelink (SL) communication, such as NR sidelink communication.

The term “terminal device” or “UE” refers to any end device that may be capable of wireless communication, more particularly cellular wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the case of multiple access nodes in the communication network, the access nodes may be connected to each other with an interface. LTE specifications call such an interface as X2 interface. For IEEE 802.11 network (i.e. wireless local area network, WLAN, WiFi), a similar interface may be provided between access points. An interface between an LTE access point and a 5G access point, or between two 5G access points may be called Xn. Other communication methods between the access nodes may also be possible. The access nodes 110 and 112 may be further connected via another interface to a core network 116 of the cellular communication system. The LTE specifications specify the core network as an evolved packet core (EPC), and the core network may comprise a mobility management entity (MME) and a gateway node. The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (5GC), and there the core network may comprise e.g. an access and mobility management function (AMF) and a user plane function/gateway (UPF), to mention only a few. The AMF may handle termination of non-access stratum (NAS) signalling, NAS ciphering & integrity protection, registration management, connection management, mobility management, access authentication and authorization, security context management. The UPF node may support packet routing & forwarding, packet inspection and QoS handling, for example.

Networks such as 5G advanced and 6G are expected to adopt flexible decentralized and/or distributed computing systems and architecture and ubiquitous computing, with local spectrum licensing, spectrum sharing infrastructure sharing, and intelligent automated management underpinned by mobile edge computing, artificial intelligence (AI), machine learning (ML), short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

AI/ML functions may be used for various tasks in communication networks. Some of the use cases for 3GPP AI/ML study are set to focus on:
Initial set of use cases includes:
   CSI feedback enhancement, e.g., overhead reduction, improved accuracy, prediction [RAN1]
   Beam management, e.g., beam prediction in time, and/or spatial domain for overhead and latency reduction, beam selection accuracy improvement [RAN1]
   Positioning accuracy enhancements for different scenarios including, e.g., those with heavy NLOS conditions [RAN1]
Finalize representative sub use cases for each use case for characterization and baseline performance evaluations by RAN #98
   The AI/ML approaches for the selected sub use cases need to be diverse enough to support various requirements on the gNB-UE collaboration levels

For example, Type II channel state information (CSI) feedback overhead has been identified as one problem in the 3GPP discussions. To achieve a good performance of Type II CSI feedback, hundreds of feedback bits may need to be sent which in turn eats up the UL data bandwidth. In 3GPP RAN1 AI/ML study item, CSI feedback overhead reduction is included as a priority use case.

For downlink CSI feedback procedure, network node may perform CSI-RS transmission which the UE may measure and provide feedback to the network node based on CSI computation (e.g. based on Type II CSI). Based on CSI feedback, network node may perform downlink data scheduling for the UE. The UE reports CSI parameters to the access network node (network node, such as gNB) as feedback. In general, CSI may include parameters, such as the channel quality indicator (CQI), precoding matrix indicator (PMI), and/or rank indicator (RI), for multiple input multiple output (MIMO) scenarios. Upon receiving the CSI parameter(s), the gNB schedules downlink data transmissions (such as modulation scheme, code rate, number of transmission layers, and MIMO precoding) accordingly.

To improve CSI feedback, it is possible to either reduce feedback bits while keep the same CSI feedback performance or keep the same feedback bits while improve the CSI feedback performance. Both these ways improve the tradeoff between CSI feedback overhead and CSI feedback performance. CSI feedback performance can be measured as channel recovery mean square error (MSE) at gNB side. Channel recovery may represent how well the channel may be recovered at the gNB side as understood by the skilled person in the art.

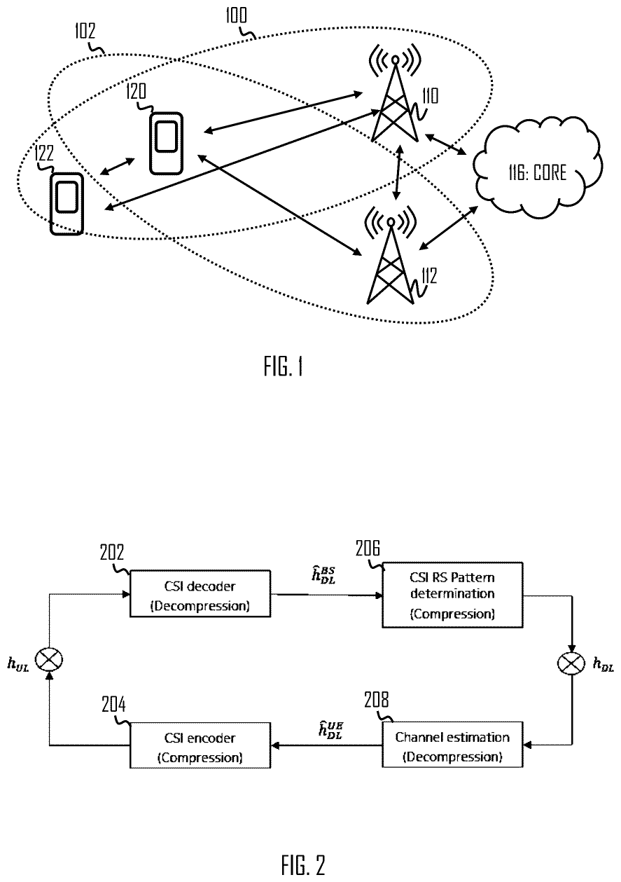

FIG. 2 represents one example of multi-step CSI feedback procedure which may be utilized in modern cellular networks. As shown in FIG. 2, CSI feedback procedure may be modelled into two steps: channel estimation 208 and CSI encoder 204, both of which may be involved with high complexity computation, especially for the CSI encoder module and when Type II CSI feedback is configured to be reported. Type II CSI feedback requires to calculate Eigen Decomposition of the multiple antenna channel and Eigen Decomposition is renowned to be highly complex and resource consuming, though several commercial libraries have been working on improving the efficiency. Block 202 shows channel decompression which may be understood in principle as a reversing step of Block 204. Block 206 represents CSI-RS pattern determination, therefore can be interpreted as a channel compression step.

Besides the complexity issue, the two steps modelling of CSI feedback procedure is also against the data processing theorem and off the optimal tradeoff points between CSI feedback overhead and CSI feedback performance. With the channel estimation module seen as a step decompressing the channel on the full TTI-PRB resource grid with 12×14 REs from the channel on a few pilot REs and the CSI encoder module seen as a step compressing the channel on the full TTI-PRB resource grid into the CSI feedback bits container, this two step decompression-compression procedure loses information, compared to one step go through processing directly from the channel on pilot REs to the feedback bits.

In summary, the legacy two step CSI feedback procedure may be improved in view of both CSI feedback performance (e.g., improve channel recovery performance with fixed feedback bits number) and computation complexity reduction.

Hence, there is provided a solution to improve the CSI feedback procedure by utilizing ML method for direct quantization of the channel on the pilots to derive CSI feedback bits.

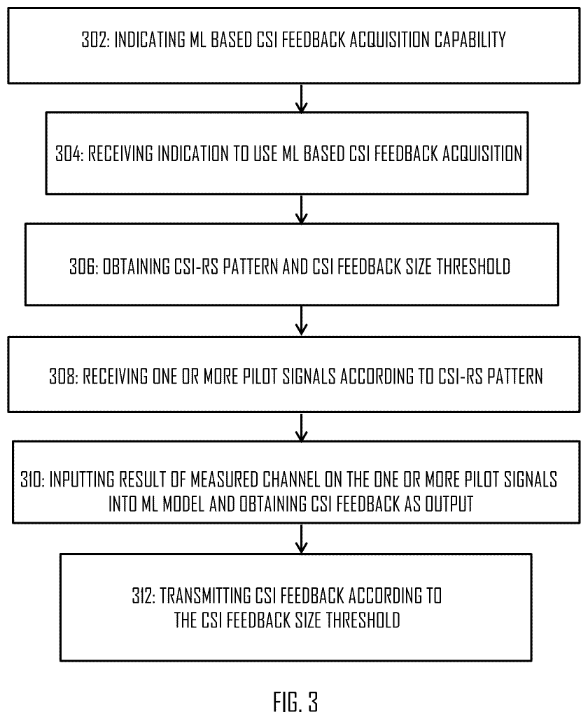

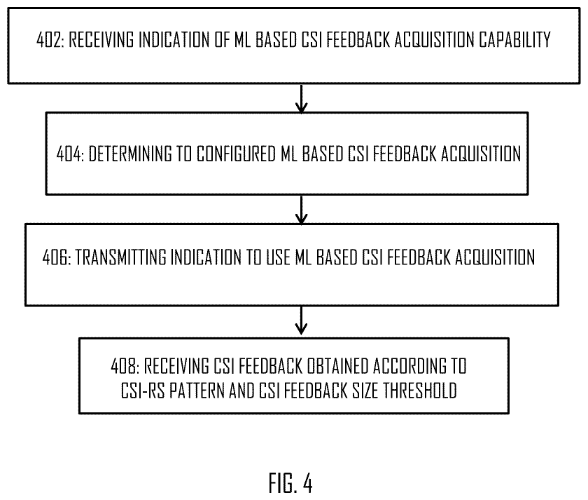

FIGS. 3 and 4 illustrate flow diagrams of the proposed solution according to some embodiments. Referring to FIG. 3, a method for an apparatus of radio access network (RAN), such as cellular communication network, is proposed. The apparatus may be a UE or be comprised in a UE. The UE may be, for example, UE 120 or UE 122.

The method of FIG. 3 may comprise: indicating, to a network node of a cellular communication network, capability to support machine learning (ML) based channel state information (CSI) feedback acquisition (block 302); receiving, from the network node, an indication to use the ML based CSI feedback acquisition (block 304); obtaining a CSI-reference signal (CSI-RS) pattern and a CSI feedback size threshold (block 306); receiving one or more pilot signals on at least one channel according to the CSI-RS pattern (block 308); inputting a result of at least one measured channel on the one or more pilot signal into an ML model and obtaining CSI feedback as an output from the ML model (block 310); transmitting, to the network node, the CSI feedback according to the CSI feedback size threshold (block 312).

The apparatus may measure the received one or more pilot signals to obtain measured channel on the one or more pilot signals. The measured channel may be inputted into the ML model to obtain the CSI feedback. The at least one channel is carried on the one or more pilot signals and the one or more pilot signals are for channel acquisition. Hence, the result of the at least one measured channel may be obtained using the one or more pilot signals.

Referring to FIG. 4, a method for an apparatus of radio access network (RAN), such as cellular communication network, is proposed. The apparatus may be a network node or be comprised in a network node. The network node may be, for example, network node 110 or network node 112.

The method of FIG. 4 may comprise: receiving, from a user equipment (e.g. UE 120, 122) of a cellular communication network, an indication of a capability to support machine learning (ML) based channel state information (CSI) feedback acquisition (block 402). This receiving step may correspond to the indicating step of block 302.

The method may comprise determining, based on the received indication of block 402, to configure the ML based CSI feedback acquisition to the user equipment (block 404); transmitting, to the user equipment, an indication to use the ML based CSI feedback acquisition (block 406); and receiving, from the user equipment, CSI feedback obtained according to a CSI-reference signal, CSI-RS, pattern and a CSI feedback size threshold (block 408).

In order to efficiently transmit CSI feedback, the UE (e.g. UE 120) may obtain uplink resource for transmitting the CSI feedback. Said uplink resource may be obtained from the network node, for example. CSI feedback may be understood to be transmitted in one or more CSI feedback containers. According to an embodiment, the CSI feedback size threshold indicates and/or configures CSI feedback container size. I.e. CSI feedback size threshold may define the size of the CSI feedback container. CSI feedback size threshold may be indicated as number of bits, for example. Thus, the CSI feedback container size may indicate number of bits for CSI feedback (i.e. number of CSI feedback bits). For example, CSI feedback container size may indicate maximum number of bits (i.e. CSI feedback bits) that fit into the container.

If the CSI feedback container size is insufficient to transmit the CSI feedback (e.g. more bits are required), the CSI feedback procedure may become inefficient. Hence, according to the proposed solution, CSI-RS pattern (abbreviated as P) and the CSI feedback size threshold (abbreviated as L) may be determined jointly. Thus, at least the probability of the CSI feedback size threshold being of suitable size (i.e., not too great so that resources are wasted and not too small so that all CSI feedback bits may be reported). Jointly herein may mean that the CSI-RS pattern and the CSI feedback size threshold are determined by the same apparatus (e.g. UE or network node) and at least substantially same time. For example, CSI-RS pattern and CSI feedback size threshold may determined at the same time. It may thus be understood that the CSI-RS pattern and CSI feedback size threshold are linked to each other, e.g. they may be linked to each other so that determining one of the parameters or the parameter itself may be taken into account when determining the other one of the parameters.

Determining the CSI-RS pattern and the CSI feedback size threshold may be based on estimation or measurement of radio channel characteristics. Radio channel herein may refer to channel that is used for transmitting the CSI-RSs according to the CSI-RS pattern. For example, for a certain CSI-RS pattern with certain channel characteristics (or radio conditions), a certain number of CSI feedback bits may be needed. Thus, the CSI feedback size threshold may be determined so that said certain number of CSI feedback bits may fit into the CSI feedback container used to transmit the CSI feedback from the UE (e.g. 120) to the network node (e.g. 110).

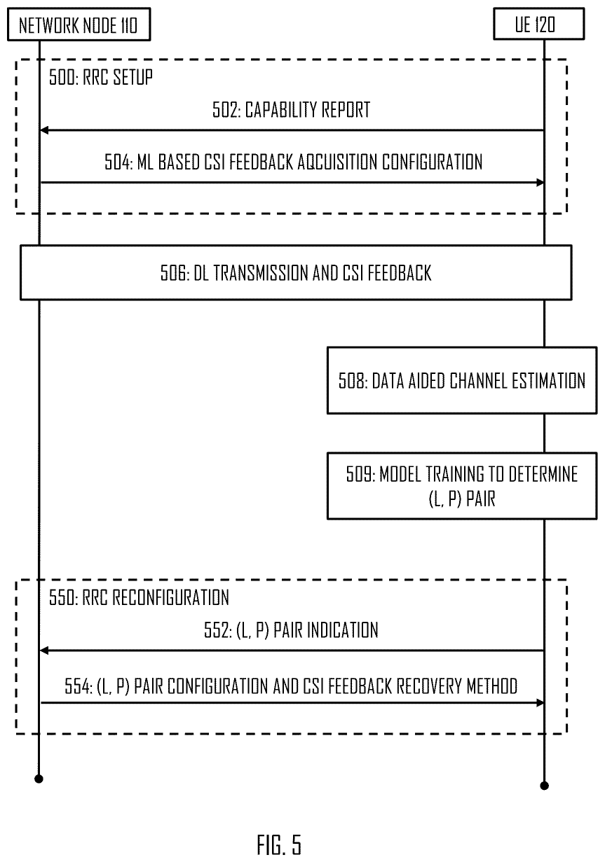

Let us now look at FIG. 5 illustrating a signaling diagram according to some example embodiments. According to an embodiment, with reference to FIG. 5, indication of block 302 of FIG. 3 may be performed using radio resource control (RRC) signaling. Thus, the indication may be an RRC indication or included in RRC message. This is shown in FIG. 5 as RRC setup 500 message. For example, capability report 502 according to an RRC signaling may be transmitted from the UE 120 to the network node 110, wherein the capability report 502 may indicate that the UE 120 supports or has the capability to support ML based CSI feedback acquisition.

The ML based CSI feedback acquisition may refer to, for example, direct quantization CSI feedback in which the measured channel on CSI-RS is directly inputted into ML model to obtain CSI feedback. Therefore, there's no need for e.g. two-step CSI feedback procedure. The ML model may be trained to directly provide the CSI feedback based on the measured channel on CSI-RS. This provides a clear benefit by reducing the steps (or merging two steps into one) needed to obtain CSI feedback. One example of ML model structure is Convolutional Neural Network (CNN). Thus, for example, the used ML model may be CNN model.

In an embodiment, the UE 120 inputs the result of the at least one measured channel on the CSI-RS(s) directly into the ML model. The result of the at least one measured channel on the CSI-RS or CSI-RSs may be directly inputted into the ML model without decompressing.

The network node 110 may receive the capability report during RRC setup 500 and determined to configure the UE 120 for ML based CSI feedback acquisition (e.g. the direct quantization CSI feedback). In step 504, the network node 110 may transmit an indication to the UE 120 to use the ML based CSI feedback acquisition.

Going one step back, according to an embodiment, the capability report 502 indicates whether or not UE 120 supports ML based CSI feedback acquisition (e.g. whether or not UE 120 supports direct quantization CSI feedback).

Additionally, according to an embodiment, the UE 120 may indicate to the network node 110 CSI-RS pattern (P) and CSI feedback size threshold (L). That is, (L, P)-pair. Indicated (L, P)-pair may be based on historical information, such as UE's 120 (L, P)-pair from earlier or previous session. For example, the UE 120 may store the (L, P)-pair or pairs from previous session(s) in its memory. The indicated (L, P)-pair may understood as recommendation or suggestion by the UE 120 for (L, P)-pair for the current session. According to an embodiment, the (L, P)-pair is comprised in or indicated by the capability report 502. However, it is possible for the UE 120, depending on the implementation, to transmit the (L, P)-pair separately from the indication that the UE 120 is capable of ML based CSI feedback acquisition. Furthermore, the (L, P)-pair indication may be beneficial at least to save computational resources, but not always necessary as (L, P)-pair may be, for example, determined and configured by the network node 110.

In an embodiment, the UE 120 indicates a plurality of (L, P) pairs. E.g. each indicated pair may be a pair that has been used by the UE 120 in earlier or previous session(s).

In an embodiment, the (L, P)-pair is indicated by the UE 120 if the UE 120 supports ML based CSI feedback acquisition. In an embodiment, (L, P)-pair indication may be implicit indication that the UE 120 supports the ML based CSI feedback acquisition.

In an embodiment, if the UE 120 does not support ML based CSI feedback acquisition, the UE 120 may not indicate the (L, P)-pair. In such case, the UE 120 may indicate, to the network node 110, that it does not support ML based CSI feedback acquisition. For example, such indication may indicate that the UE 120 supports the two-step CSI feedback acquisition.

In an embodiment, the indication whether or not UE 120 supports ML based CSI feedback acquisition (e.g. whether or not UE 120 supports direct quantization CSI feedback) is a bit indicator comprising one or more bits. In an example, the bit indicator is one-bit indicator, wherein 0 or 1 indicates that the UE 120 supports ML based CSI feedback acquisition and the other one of 0 and 1 indicates that the UE does not support ML based CSI feedback acquisition. For example, 1 may indicate support for ML based CSI feedback acquisition (e.g. direct quantization CSI feedback), whereas 0 may indicate that ML based CSI feedback acquisition (e.g. direct quantization CSI feedback) is not supported or UE only supports the legacy CSI feedback procedure or procedures. For example, the UE 120 may determine whether it supports the ML based CSI feedback acquisition and based on the determining, generate the indicator to represent the result of the determination. Subsequently, the indicator (e.g. 0/1 or any other suitable indicator) may be transmitted to the network node e.g. as shown in step 502.

Additionally, according to an embodiment, the UE 120 may indicate to the network node 110 CSI feedback recovery method. For example, the UE 120 may indicate CSI feedback recovery method that was used by the UE 120 in earlier or previous session. The CSI feedback recovery method indication may be understood as suggestion or recommendation by the UE 120 to the network node 110. In an embodiment, the capability report 502 comprises the CSI feedback recovery method indication. However, the CSI feedback recovery method indication may be performed separately depending on implementation.

Therefore, depending on the implementation and whether UE 120 supports the ML based CSI feedback recovery method, the capability report 502 may indicate whether UE 120 supports the ML based CSI feedback and/or (L, P)-pair suggestion(s) and/or CSI feedback recovery method suggestion.

Based on the indication(s) in step 502, the network node 110 may determine to configure the UE 120 for CSI feedback. Based on the UE 120 indicating that it supports ML based CSI feedback acquisition, the network node 110 may determine to configure the UE with ML based CSI feedback acquisition. Otherwise, the network node 110 may configure the UE 120 for e.g. two-step CSI acquisition according to legacy operation and as defined e.g. in 3gpp.

For example, when UE 120 indicates to the network node 110 during RRC setup 500 (or RRC setup stage) that it supports the ML based CSI feedback acquisition procedure, network node 110 may indicate to the UE 120 which CSI feedback procedure is applied, the legacy one or the ML based CSI feedback acquisition (e.g. direct quantization CSI feedback). Such indication may be done by a one-bit indicator: e.g. when “1” is indicated, UE 120 applies the ML based CSI feedback acquisition, and when “0” is indicate, UE 120 applies the legacy CSI feedback procedure. Such indication (one-bit or some other type of indicator) may be transmitted in step 504. In some examples, this indication may be understood as part of ML based CSI feedback acquisition configuration as shown in step 504.

Additionally, in some embodiments, the network node 110 may indicate (L, P)-pair and/or CSI recovery method in step 504 (i.e. during RRC setup 500) to the UE 120. CSI recovery method may indicate how the network node 110 recovers the CSI feedback bits and reconstructs the channel that is used for scheduling DL transmission. For example, the network node 110 may use the indicated CSI recovery method.

In an embodiment, the network node 110 indicates amongst a plurality of predefined CSI recovery methods the CSI recovery method to be used by the network node 110. For example, CSI recovery methods and corresponding indicators may be defined in specification(s). Thus, by sending an indicator corresponding to needed CSI recovery method, said CSI recovery method may be indicated to the UE 120. For example, a RRC message field may be used for the indication (i.e. RRC indicator). Thus, the UE may determine which CSI recovery method the network node 110 uses.

In an embodiment, the network node 110 may determine the CSI recovery method and/or (L, P)-pair based at least on recommendation from the UE 120 (see step 502). Additionally or alternatively, determining the CSI recovery method and/or (L, P)-pair may be based on history information regarding one or more other UEs. For example, the network node 110 may have participated in session(s) with said one or more other UEs and may utilize the information on the CSI recovery method and/or (L, P)-pair from said session(s).

Indication of the CSI recovery method or use of multiple CSI recovery methods may not always be necessary as the UE 120 may be configured to utilize default CSI feedback recovery method (e.g. same or similar as the one used in Type II CSI feedback acquisition). With the legacy CSI feedback recovery method, the proposed direct quantization CSI feedback works, as the ML based method may adapt CNN to any predefined recovery method through training process. However, it may be beneficial to utilize simplified recovery method(s) as they can potentially reduce computation complexity while maintain the channel recovery performance. One such example would be to directly apply feedback bits (i.e. CSI feedback bits) as CSI.

The network node 110, in cases ML based CSI feedback acquisition is indicated to the UE 120, may indicate at same or different time the CSI feedback size threshold and associated CSI-RS pattern (i.e., the (L, P)-pair). The (L, P)-pair is determined jointly. In legacy CSI feedback procedure, CSI feedback size and CSI-RS pattern are configured and determined separately. For example, number of CSI feedback bits is implicitly configured with number of feedback beams and correspondent co-phasing quantization bit width. However, for the direct quantization CSI feedback, only one number of the total feedback bits (i.e. L) may be configured.

Network node 110 may signal L and P together to the UE 120, e.g. in step 504. (L, P)-pair, can be determined, by the network node 110, based on the selected CSI feedback recovery method and the expected channel recovery performance which may be represented by e.g. mean square error (MSE). For example, for one CSI feedback recovery method, several (L, P) pairs may be defined in a joint encoding way to achieve different channel recovery MSE while saving the signaling overhead.

In an embodiment, (L, P) pairs are mapped with corresponding indicators such as indexes. For example, network node may indicate (L, P) pair to be used by transmitting the corresponding indicator to the UE 120 e.g. as RRC information element in step 504. UE 120 may then determine the (L, P) pair to be used based on the mapping and the received (L, P) pair indicator. Such mapping may be achieved e.g. with a table indexing the (L, P) pairs. For example, the table may be defined in one or more specifications such as 3gpp specification(s).

As an example, default configuration for (L, P) pair may be calculated, e.g. by the network node 110, using the legacy Type II CSI feedback procedure with a maximum possible CSI feedback container size and a CSI-RS pattern with a largest possible number of pilot resource elements (REs) (or CSI-RSs). This may guarantee the CSI feedback performance at the very beginning. However, as is later discussed, in such case the (L, P) pair indication by the network node 110 to the UE 120 may be understood as initial (L, P) pair indication and later step(s) in the procedure may enable the UE 120 to determine better (L, P) pair which does enable CSI feedback acquisition to work more efficiently (e.g. less feedback bits or less CSI-RS pilots).

Additionally, in some embodiments, the network node 110 provides, to the UE 120, one or more parameters for the ML model for determining CSI feedback. E.g. CNN parameter(s). Said parameter(s) may be transmitted in step 504, for example. For example, the parameter(s) may configure the ML model and/or indicate which ML model to be used in case the UE 120 has multiple ML models which it may use.

In block 506, the network node 110 may transmit CSI-RS(s) according to the CSI-RS pattern and UE 120 may monitor and receive CSI-RS(s) according to the CSI-RS pattern. UE 120 may subsequently provide the CSI feedback to the network node 110. As discussed herein, the CSI feedback may be obtained using the ML based CSI acquisition (e.g. direct quantization CSI feedback). The CSI feedback may be reported to the network node according to the constraints set by the CSI feedback size threshold.

The direct quantization CSI feedback may work with the proposed initial (L, P)-pair obtained e.g. from the network node 110, but the CSI feedback acquisition may be even further improved by providing an enhanced way to determine (L, P)-pair. With reference to FIG. 5, one example of such process is shown to be performed by the UE 120. However, it is noted that the (L, P)-pair determination may instead be performed at the network node 110 or some other network node, and the results may be provided to the UE 120.

Referring now to FIG. 5, in block 508, UE 120 performs data aided channel estimation. At this point it is noted that performing e.g. step 508 may not always necessarily require the performance of steps 502-506, although it may be beneficial to obtain the initial (L, P)-pair from the network node 110 before performing step 508.

In an embodiment, the data aided channel estimation comprises measuring a channel between UE 120 and the network node 110. The channel may be the channel used for transmitting CSI-RSs.

In an embodiment, the data aided channel estimation comprises measuring, by the UE 120, full channel grid of the channel between UE and the network node. Simply put, this may mean that the UE 120 measures the whole channel instead of only measuring the CSI-RSs according to the CSI-RS pattern. For example, the measurement of the full channel may be performed in block 506. Therefore, the block 508 may be a part of block 506 is some examples.

Therefore, training/test data in the proposed ML model (e.g. CNN) based method is UE channel on the full Transmission Time Interval-Physical Resource Block (TTI-PRB) resource grid. The full TTI-PRB resource grid may be acquired using data aided channel estimation at UE side or combing with UL-DL reciprocity at network node 110 side. Data aided channel estimation is a feature for improving the channel estimation performance. When a transmission block is successfully decoded, the decoded data REs can be seen as pilot. Using the decoded data REs together with the reference signal REs, it is possible to acquire the channel frequency response for the whole transmission block, therefore the channel on the full TTI PRB grid.

In block 509, the UE may determine CSI-RS pattern and the CSI feedback size threshold based on the data aided channel estimation. I.e. the data aided channel estimation performed by the UE 120. Block 509 may comprise ML model training to determine CSI-RS pattern and the CSI feedback size threshold. In an example embodiment, the UE determines optimized or optimal CSI-RS pattern and the CSI feedback size threshold based on the data aided channel estimation. For example, model training may include determining ground truth of the channel based on data aided channel estimation and then selecting the CSI-RS pattern and CSI feedback size threshold by comparing MSE of different CSI-RS pattern and CSI-feedback size threshold pairs. MSE for certain (L, P)-pair may be obtained by comparing channel estimation obtained using said pair with the ground truth of the channel.

Let us then look at some examples on how to perform the determination of CSI-RS pattern and CSI feedback size threshold which may be performed at the same time.

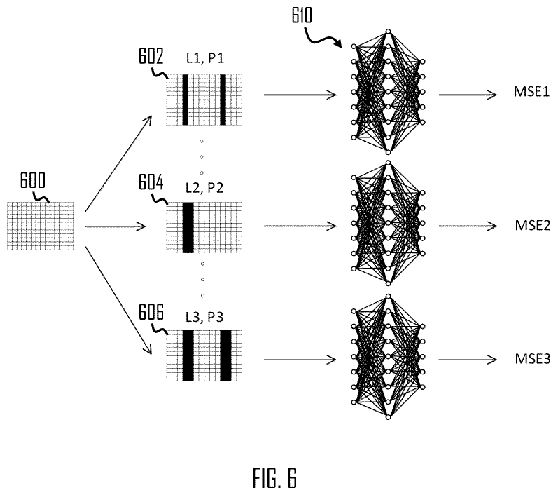

The result of the measured full channel or full channel grid may be used as a training data for the ML model to determine (L, P)-pair. For example, the UE 120 may determine, utilizing the ML model for the CSI feedback acquisition and the training data, a plurality of CSI feedbacks, wherein each of the determined plurality of CSI feedbacks is associated with a corresponding CSI-RS pattern and CSI feedback size threshold pair. Example of this is shown in FIG. 6 illustrating an embodiment.

Referring to FIG. 6, the measured channel grid is shown with reference number 600. The measured channel grid may be understood as training data. As described above, the measured channel grid may be measured full channel grid. However, in some examples or implementations, the measured channel grid may refer to the measured channel on the resources (e.g. REs) that include the CSI-RS(s) indicated by the CSI-RS pattern and some further resources. Therefore, it may be so that e.g. almost all resources of the channel are measured, but not necessarily all.

In an embodiment, measuring the channel grid comprises measuring the full channel grid.

Multiple different CSI-RS patterns (e.g. P1, P2, and P3) may be utilized by the UE 120 to obtain different patterns from the measured channel grid. These are shown with reference numbers 602, 604, and 606. That is, different REs of the measured channel grid 600 may be obtained, as the channel grid 600 has been measured, and be used as input for the ML model 610.

Each CSI-RS pattern may be associated with a corresponding CSI feedback size threshold (L1, L2, L3) as shown in FIG. 6. As described above, CSI feedback size threshold and CSI-RS pattern may form a pair, e.g. L1, P1; L2, P2; and L3; P3.

The CSI feedback size threshold and CSI-RS pattern may be determined by the UE 120. The determination may be based on UE implementation, information from network node 110 and/or reconfiguration. For example, the different resources selected based on the patterns 602, 604, 606 may be inputted into the ML model 610 and CSI feedback may be obtained as output. Different (L, P)-pairs may provide different MSEs. For example, as shown in FIG. 6, (L1, P1)-pair may be associated with MSE1, (L2, P2)-pair may be associated with MSE2, and (L3, P3)-pair may be associated with MSE3. That is, CSI feedback obtained with different (L, P)-pairs using the associated measured channel (i.e. measured resources) as input for the ML model 610 (e.g. CNN) may provide different CSI feedbacks and these CSI feedbacks may be compared with the measured channel to determine which used (L, P)-pair provides the lowest MSE. For example, MSE may be determined based on comparing the currently determined CSI feedback to the measured channel 600. For example, the UE 120 may select, as the ground truth, the measured channel (characterizing the channel) that is obtained using data aided channel estimation. UE 120 may obtain one or more CSI feedbacks (i.e. channel recovery(s)) using one or more (L, P)-pairs. UE 120 may then compare respective CSI feedback with the ground truth measured channel and determine MSE for the respective CSI feedback based on the comparison. Thus, MSE for one or more (L, P)-pairs may be obtained. For example, the UE 120 may select (L, P)-pair that is associated with lowest MSE amongst the MSE(s) determined based on comparing the ground truth channel against the channel recovery using the one or more (L, P)-pairs.

Hence, UE 120 may obtain CSI-RS pattern and the CSI feedback size threshold based on using the data aided channel estimation and ML model training as shown in steps 508 and 509 and as explained with reference to FIG. 6. I.e. the UE 120 may compare the determined plurality of CSI feedbacks, and select CSI-RS pattern and CSI feedback size threshold pair based on the comparing. That is, UE 120 may select pair that is associated with lowest estimated MSE, for example. As discussed, (L, P)-pair specific MSE for each pair may be determined by comparing the CSI feedback against ground truth of the measured channel.

For example, several (L, P) pairs can be specified following the legacy CSI feedback container sizes and the legacy CSI-RS patterns in the current standard. For each of the (L, P) pair, a CNN can be constructed. Training and testing of these CNNs can be performed in parallel. For example, pair that meets MSE requirement with least overhead (weighted sum of the number of the CSI RS pilot REs and the CSI feedback container size) may be selected. It is noted that CNN for direct quantization CSI feedback may be relatively simple and with only a few layers, and thus the training and testing could be done quickly. It is also noted that this trial and selection method can be also applied if CSI recovery methods, other than the legacy one, are defined and configured.

The determined (i.e. by the UE 120) CSI-RS pattern and CSI feedback size threshold may be signaled from the UE 120 to the network node 110 or at least indicated by the UE 120 to the network node 110. For example, and as discussed below in more detail, the indication of the CSI-RS pattern and the CSI feedback size threshold may be performed via RRC signaling, such as via RRC reconfiguration.

It is again noted that the determination of the CSI-RS pattern and the CSI feedback size threshold may alternatively be performed by the network node 110 similarly as explained with reference to the UE 120 determining the CSI-RS pattern and the CSI feedback size threshold.

In some examples, the UE 120 receives, from the network node 110, a CSI-RS pattern and a CSI feedback size threshold to be used (e.g. in step 308 and 312) for obtaining the CSI feedback to be transmitted to the network node 110. For example, the CSI-RS pattern and the CSI feedback size threshold may be received after and/or based on indicating the determined or selected CSI-RS pattern and the CSI feedback size threshold to the network node 110. On the other hand, if the CSI-RS pattern and CSI feedback size threshold are determined at the network node 110 utilizing the method as explained with reference to the steps 308, 309, such indication by the UE 120 may not be necessary.

In cases where the UE 120 indicates the determined and/or selected CSI-RS pattern and CSI feedback size threshold to the network node 110, the network node 110 may utilize the indicated CSI-RS pattern and CSI feedback size threshold in determining the CSI-RS pattern and CSI feedback size threshold to be used by the UE 120 for determining the CSI feedback. In an example, the network node 110 may confirm the determined and/or selected CSI-RS pattern and CSI feedback size threshold to the UE 120. Anyway, at least in some examples, the network node 110 may be able to configure CSI-RS pattern and CSI feedback size threshold to the UE 120 according to its determination. This may be beneficial as then both UE 120 and network node 110 may both be aware of the to be used parameter L and P for the CSI feedback utilizing the direct quantization CSI feedback procedure.

Referring now to FIG. 5, in an embodiment, the determined and/or selected, by the UE 120 based on the data aided channel estimation, CSI-RS pattern and CSI feedback size threshold are transmitted to the network node 110 using RRC signaling (step 552). For example, RRC reconfiguration 550 signaling may be used. The network node 110 may receive the RRC signaling of step 552.

In step 554, the network node 110 may respond by transmitting said to be used CSI-RS pattern and CSI feedback size threshold to the UE 120. This may be performed based on and/or in response to the RRC signaling of step 552.

In an embodiment, step 554 further includes the network node 110 indicating, to the UE 120, CSI feedback recovery method.

The UE 120 may utilize the information received from the network node in step 554 and perform CSI feedback procedure according to the information. For example, this may mean that the UE 120 measures CSI-RSs transmitted by the network node 110 according to the CSI-RS pattern, performs direct quantization using e.g. CNN, and reports the results (i.e. CSI feedback) to the network node 110 taking into account the CSI feedback container size. Similarly, network node 110 may perform the transmission of CSI-RSs according to said CSI-RS pattern, and further receive the CSI feedback from the UE 120 on given resources. The network node 110 may further utilize the CSI feedback e.g. in scheduling decision(s).

Simulation results show that with the same CSI-RS pattern and the same feedback bits number, direct quantization CSI feedback using CNN performs may perform better than the legacy two step CSI feedback procedure. Once the CNN is trained, only sequential add and multiply operations may be needed in the inference stage. So, the direct quantization CSI feedback may also lower the complexity of CSI feedback computation.

In current solutions, the CSI-RS pattern and the CSI feedback bit width are configured independently, as in the legacy method the intermediate variable, the recovered channel ĥ_{DL}^{UE} in FIG. 2, separates the two modules, the channel estimation and the CSI encoder, so there may be no performance loss by doing so. For the direct quantization CSI feedback, there is no such intermediate variable to separate or orthogonalize the two steps of decompression (channel estimation) and compression (CSI encoder). Instead, one step go through processing is applied. Therefore, they are highly correlated and it is beneficial that both are determined/configured together: the CSI-RS pattern (the number of the CSI-RS REs and their distribution in the TTI-PRB resource grid) and the CSI feedback container size (the number of total feedback bits; referred to also as CSI feedback size threshold). Following this observation, herein it is proposed to configure the CSI-RS pattern and the CSI feedback container size (i.e. bit width) jointly.

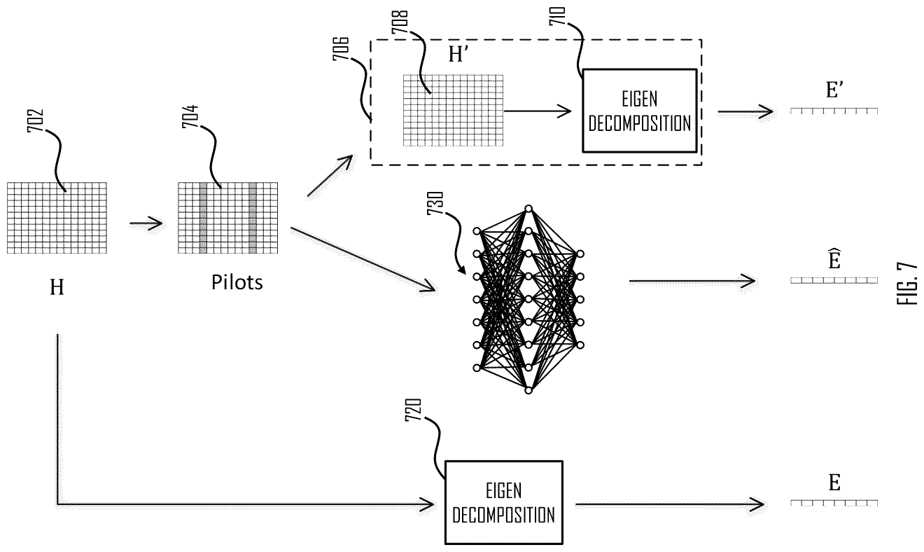

FIG. 7 represents one example comparison between CSI feedback procedure for the ground truth CSI feedback E, the legacy CSI feedback E′ and the proposed direct quantization CSI feedback Ê. This example should be understood as an example showing how the direct quantization CSI feedback may compare against the ground truth CSI feedback and/or legacy CSI feedback.

Ground truth CSI feedback E may be understood representing the channel if it would be measured optimally and without any errors or losses.

Legacy CSI feedback E′ may be understood as representing CSI feedback obtained using the two-step CSI feedback procedure e.g. Type II CSI feedback procedure.

CSI feedback E may be understood as the CSI feedback that is obtained using the described methods and processes herein. For example, it may refer to direct quantization CSI feedback.

In FIG. 7, H (also show with reference sign 702) represents the ground truth channel over full TTI-PRB resource grid. Ground truth CSI feedback E may be obtained as follows: starting from the ground truth channel H, Eigen Decomposition may be used to derive the Eigen Vectors of the channel. These Eigen Vectors may be used as the training/test labels for the ground truth CSI feedback.

Legacy CSI feedback E′ may be obtained using two-step process 706. Starting from ground truth channel H, the channel H is sampled with pilot REs based on the configured CSI-RS pattern (see reference sign 704). Then the sampled channel is recovered using interpolation and the recovered channel H′ (708) may be obtained. This may correspond to the first step in the legacy CSI feedback procedure, the channel estimation step. After this, we the recovered channel H′ is inputted into the Eigen Decomposition module 710 and the Eigen vectors may be calculated to simulate the CSI feedback for the legacy procedure. This may correspond to the second step: CSI encoder.

In direct quantization CSI feedback, instead of using channel estimation and Eigen Decomposition, the two steps are replaced with a CNN 730 to compute the CSI feedback Ê in one step, and the CNN should behave similar to a go through direct quantization function. Detail training/testing of the CNN and comparison with the legacy method is described in following.

An exemplary implementation of the CNN may include training the CNN:
input→pilots
output→Ê
labels→E
loss→MSE between E and Ê

Comparison between direct quantization CSI feedback and legacy CSI feedback:
input→pilots
MSE between E and Ê vs. MSE between E and E′

Benefit of the proposed solution may include obtaining lower MSE for direct quantization CSI feedback compared with the legacy 2 step CSI feedback procedure. This seems to align with data processing theorem; more processing may actually lead to losing more information. It is also noted that once the CNN is trained, it may only require sequential add and multiply operations for inference. The computation complexity of the direction quantization CSI feedback in the inference stage may be lower than the Eigen Decomposition based legacy procedure, for which iterative operations are involved.

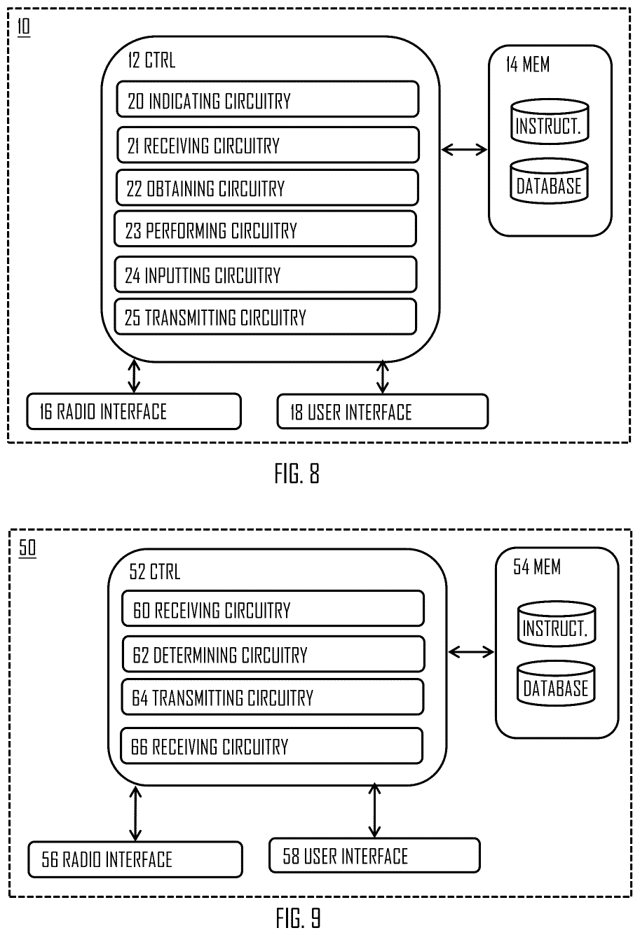

An embodiment, as shown in FIG. 8, provides an apparatus 10 comprising a control circuitry (CTRL) 12, such as at least one processor, and at least one memory 14 storing instructions (INSTRUCT.) that, when executed by the at least one processor, cause the apparatus at least to carry out any one of the above-described processes. In an example, the at least one memory and the instructions are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 10 comprises the terminal device of a communication system, e.g. a user terminal (UT), a computer (PC), a laptop, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 10 is or is comprised in the UE 120. The apparatus may be caused to execute some of the functionalities of the above described processes.

The apparatus 10 may comprise a radio interface (TRX) 16 comprising hardware and/or software for realizing communication connectivity according to one or more communication protocols. The TRX may provide the apparatus with communication capabilities to access the radio access network, for example. For example, the TRX may enable SL communication.

The apparatus may also comprise a user interface 18 comprising, for example, at least one keypad, a microphone, a touch display, a display, a speaker, etc. The user interface may be used to control the apparatus by the user.

In an embodiment, the control circuitry 12 comprises an indicating circuitry 20 for performing at least the step 302 of FIG. 3; a receiving circuitry 21 for performing at least the step 304 of FIG. 3; an obtaining circuitry 22 for performing at least the step 306 of FIG. 3; a performing circuitry 23 for performing at least the step 308 of FIG. 3; an inputting circuitry 24 for performing at least the step 310 of FIG. 3; and a transmitting circuitry 25 for performing at least the step 312 of FIG. 3.

An embodiment, as shown in FIG. 9, provides an apparatus 50 comprising a control circuitry (CTRL) 52, such as at least one processor, and at least one memory 54 storing instructions (INSTRUCT.) that, when executed by the at least one processor, cause the apparatus at least to carry out any one of the above-described processes. In an example, the at least one memory and the instructions are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 50 may be or be comprised in a network node, such as in gNB/gNB-CU/gNB-DU of 5G. In an embodiment, the apparatus is or is comprised in the network node 110. The apparatus may be caused to execute some of the functionalities of the above described processes.

The apparatus 50 may comprise a radio interface (TRX) 56 comprising hardware and/or software for realizing communication connectivity according to one or more communication protocols. The TRX may provide the apparatus with communication capabilities to access the radio access network, for example. For example, the TRX may enable SL communication.

The apparatus 50 may also comprise a user interface 58 comprising, for example, at least one keypad, a microphone, a touch display, a display, a speaker, etc. The user interface may be used to control the apparatus by the user.

In an embodiment, the control circuitry 52 comprises a receiving circuitry 60 for performing at least the step 402 of FIG. 4; a determining circuitry 62 for performing at least the step 404 of FIG. 4; a transmitting circuitry 64 for performing at least the step 406 of FIG. 4; and a receiving circuitry 66 for performing at least the step 408 of FIG. 4. In an embodiment, the receiving circuitry 60 and the receiving circuitry 66 are the same circuitry.

In an embodiment, an apparatus carrying out at least some of the embodiments described comprises at least one processor and at least one memory including instructions, that when executed by the at least one processor, cause the apparatus to carry out the functionalities according to any one of the embodiments described. According to an aspect, when the at least one processor executes the instructions, the instructions cause the apparatus to carry out the functionalities according to any one of the embodiments described. According to another embodiment, the apparatus carrying out at least some of the embodiments comprises the at least one processor and at least one memory including instructions, wherein the at least one processor and the instructions perform at least some of the functionalities according to any one of the embodiments described. Accordingly, the at least one processor, the memory, and the instructions form processing means for carrying out at least some of the embodiments described. According to yet another embodiment, the apparatus carrying out at least some of the embodiments comprises a circuitry including at least one processor and at least one memory including instructions. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

A term non-transitory, as used herein, is a limitation of the medium itself (i.e. tangible, not a signal) as opposed to a limitation on data storage persistency (e.g. RAM vs. ROM).

As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

The means of the apparatus may be implemented in hardware and/or software, for example. They may comprise for instance at least one processor for executing processor instructions for performing the required functions, at least one memory storing the instructions, or both. Alternatively, they could comprise for instance circuitry that is designed or configured to implement the required functions, for instance implemented in a chipset or a chip, like an integrated circuit. In general, the means may comprise for instance one or more processing means or processors.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Example 1. An apparatus comprising: at least one processor; and at least one memory storing instructions that, when executed by the at least one processor, cause the apparatus at least to perform: indicating, to a network node of a cellular communication network, capability to support machine learning, ML, based channel state information, CSI, feedback acquisition; receiving, from the network node, an indication to use the ML based CSI feedback acquisition; obtaining a CSI-reference signal, CSI-RS, pattern and a CSI feedback size threshold, wherein the CSI-RS pattern and the CSI feedback size threshold are determined jointly; receiving one or more pilot signals for at least one channel according to the CSI-RS pattern; inputting a result of at least one measured channel on the one or more pilot signals into an ML model and obtaining CSI feedback as an output from the ML model; transmitting, to the network node, the CSI feedback according to the CSI feedback size threshold.

Example 2. The apparatus of example 1, wherein the CSI-RS pattern and the CSI feedback size threshold are determined based on data aided channel estimation.

Example 3. The apparatus of example 2, wherein the data aided channel estimation comprises measuring a channel between the apparatus and the network node.

Example 4. The apparatus of example 3, wherein the data aided channel estimation comprises measuring full channel grid of the channel.

Example 5. The apparatus of any preceding example, caused to perform: determining the CSI-RS pattern and the CSI feedback size threshold.

Example 6. The apparatus of example 5, wherein the determining is based on history information.

Example 7. The apparatus of example 5, caused to perform: measuring a channel between the apparatus and the network node; using a result of the measuring as a training data for the ML model; determining, utilizing the ML model and the training data, a plurality of CSI feedbacks, wherein each of the determined plurality of CSI feedbacks is associated with a corresponding CSI-RS pattern and CSI feedback size threshold pair; comparing the determined plurality of CSI feedbacks; and selecting CSI-RS pattern and CSI feedback size threshold pair based on the comparing.

Example 8. The apparatus of example 5, 6, or 7, caused to perform: indicating the determined or selected CSI-RS pattern and a CSI feedback size threshold to the network node; and receiving, from the network node, a CSI-RS pattern and a CSI feedback size threshold to be used for obtaining the CSI feedback to be transmitted to the network node.

Example 9. The apparatus of any preceding example 1 to 4, caused to perform: receiving, from the network node, the CSI-RS pattern and the CSI feedback size threshold.

Example 10. The apparatus of any preceding example, caused to perform: receiving, from the network node, indication of a CSI recovery method to be used.

Example 11. The apparatus of any preceding example, caused to perform: transmitting at least one indicator bit to the network node, the at least one indicator bit indicating the capability to support ML based CSI feedback acquisition.

Example 12. The apparatus of example 11, wherein the at least one indicator bit is transmitted in a radio resource control, RRC, message.

Example 13. The apparatus of any preceding example, wherein the result of the at least one measured channel is directly inputted into the ML model without decompressing.

Example 14. An apparatus comprising: at least one processor; and at least one memory storing instructions that, when executed by the at least one processor, cause the apparatus at least to perform: receiving, from a user equipment, UE, of a cellular communication network, an indication of a capability to support machine learning, ML, based channel state information, CSI, feedback acquisition; based on the indication, determining to configure the ML based CSI feedback acquisition to the user equipment; transmitting, to the user equipment, an indication to use the ML based CSI feedback acquisition; and receiving, from the user equipment, CSI feedback obtained according to a CSI-reference signal, CSI-RS, pattern and a CSI feedback size threshold.

Example 15. The apparatus of example 14, further caused to: indicating, to the user equipment, the CSI-RS pattern and the CSI feedback size threshold.

Example 16. The apparatus of example 15, wherein the CSI-RS pattern and the CSI feedback size threshold are determined based on data aided channel estimation.

Example 17. The apparatus of example 16, wherein the data aided channel estimation comprises measuring a channel between the apparatus and the user equipment.

Example 18. The apparatus of example 16, wherein the data aided channel estimation comprises measuring full channel grid of the channel.

Example 19. The apparatus of any preceding example 14 to 18, caused to perform: determining or selecting the CSI-RS pattern and the CSI feedback size threshold; and indicating the determined or selected CSI-RS pattern and the CSI feedback size threshold.

Example 20. The apparatus of example 19, caused to perform: receiving CSI-RS pattern and the CSI feedback size threshold proposal from the user equipment; and determining or selecting the CSI-RS pattern and the CSI feedback size threshold at least based on the received CSI-RS pattern and the CSI feedback size threshold proposal.

Example 21. The apparatus of example 19, wherein the determining or selecting the CSI-RS pattern and the CSI feedback size threshold is based on history information on at least one user equipment.

Example 22. An apparatus comprising:
means for indicating, to a network node of a cellular communication network, capability to support machine learning, ML, based channel state information, CSI, feedback acquisition; means for receiving, from the network node, an indication to use the ML based CSI feedback acquisition; means for obtaining a CSI-reference signal, CSI-RS, pattern and a CSI feedback size threshold, wherein the CSI-RS pattern and the CSI feedback size threshold are determined jointly; means for receiving one or more pilot signals for at least one channel according to the CSI-RS pattern; means for inputting a result of at least one measured channel on the one or more pilot signals into an ML model and obtaining CSI feedback as an output from the ML model; and means for transmitting, to the network node, the CSI feedback according to the CSI feedback size threshold.

Example 23. An apparatus comprising: means for receiving, from a user equipment, UE, of a cellular communication network, an indication of a capability to support machine learning, ML, based channel state information, CSI, feedback acquisition; means for determining, based on the indication, to configure the ML based CSI feedback acquisition to the user equipment; means for transmitting, to the user equipment, an indication to use the ML based CSI feedback acquisition; and means for receiving, from the user equipment, CSI feedback obtained according to a CSI-reference signal, CSI-RS, pattern and a CSI feedback size threshold.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising:
at least one processor; and
at least one memory storing instructions that, when executed by the at least one processor, cause the apparatus at least to perform;
indicating, to a network node of a cellular communication network, capability to support machine learning, ML, based channel state information, CSI, feedback acquisition;
receiving, from the network node, an indication to use the ML based CSI feedback acquisition;
obtaining a CSI-reference signal, CSI-RS, pattern and a CSI feedback size threshold, wherein the CSI-RS pattern and the CSI feedback size threshold are determined jointly;
receiving one or more pilot signals for at least one channel according to the CSI-RS pattern;
inputting a result of at least one measured channel on the one or more pilot signals into an ML model and obtaining CSI feedback as an output from the ML model;
transmitting, to the network node, the CSI feedback according to the CSI feedback size threshold.

2. The apparatus of claim 1, wherein the CSI-RS pattern and the CSI feedback size threshold are determined based on data aided channel estimation.

3. The apparatus of claim 2, wherein the data aided channel estimation comprises measuring a channel between the apparatus and the network node.

4. The apparatus of claim 3, wherein the data aided channel estimation comprises measuring full channel grid of the channel.

5. The apparatus of claim 1, caused to perform:
determining the CSI-RS pattern and the CSI feedback size threshold.

6. The apparatus of claim 5, wherein the determining is based on history information.

7. The apparatus of claim 5, caused to perform:
measuring a channel between the apparatus and the network node;
using a result of the measuring as a training data for the ML model;
determining, utilizing the ML model and the training data, a plurality of CSI feedbacks, wherein each of the determined plurality of CSI feedbacks is associated with a corresponding CSI-RS pattern and CSI feedback size threshold pair;
comparing the determined plurality of CSI feedbacks; and
selecting CSI-RS pattern and CSI feedback size threshold pair based on the comparing.

8. The apparatus of claim 5, caused to perform:
indicating the determined or selected CSI-RS pattern and a CSI feedback size threshold to the network node; and
receiving, from the network node, a CSI-RS pattern and a CSI feedback size threshold to be used for obtaining the CSI feedback to be transmitted to the network node.

9. The apparatus of claim 1, caused to perform:
receiving, from the network node, the CSI-RS pattern and the CSI feedback size threshold.

10. The apparatus of claim 1, caused to perform:
receiving, from the network node, indication of a CSI recovery method to be used.

11. The apparatus of claim 1, caused to perform:
transmitting at least one indicator bit to the network node, the at least one indicator bit indicating the capability to support ML based CSI feedback acquisition.

12. The apparatus of claim 11, wherein the at least one indicator bit is transmitted in a radio resource control, RRC, message.

13. The apparatus of claim 1, wherein the result of the at least one measured channel is directly inputted into the ML model without decompressing.

14. An apparatus comprising:
at least one processor; and
at least one memory storing instructions that, when executed by the at least one processor, cause the apparatus at least to perform;
receiving, from a user equipment, UE, of a cellular communication network, an indication of a capability to support machine learning, ML, based channel state information, CSI, feedback acquisition;
based on the indication, determining to configure the ML based CSI feedback acquisition to the user equipment;
transmitting, to the user equipment, an indication to use the ML based CSI feedback acquisition; and
receiving, from the user equipment, CSI feedback obtained according to a CSI-reference signal, CSI-RS, pattern and a CSI feedback size threshold.

15. The apparatus of claim 14, further caused to:
indicating, to the user equipment, the CSI-RS pattern and the CSI feedback size threshold.

16. The apparatus of claim 15, wherein the CSI-RS pattern and the CSI feedback size threshold are determined based on data aided channel estimation.

17. The apparatus of claim 14, caused to perform:
determining or selecting the CSI-RS pattern and the CSI feedback size threshold; and
indicating the determined or selected CSI-RS pattern and the CSI feedback size threshold.

18. The apparatus of claim 17, caused to perform:
receiving CSI-RS pattern and the CSI feedback size threshold proposal from the user equipment; and
determining or selecting the CSI-RS pattern and the CSI feedback size threshold at least based on the received CSI-RS pattern and the CSI feedback size threshold proposal.

19. The apparatus of claim 17, wherein the determining or selecting the CSI-RS pattern and the CSI feedback size threshold is based on history information on at least one user equipment.

20. A method, comprising:
indicating, by an apparatus of a cellular communication network to a network node of the cellular communication network, capability to support machine learning, ML, based channel state information, CSI, feedback acquisition;
receiving, from the network node, an indication to use the ML based CSI feedback acquisition;
obtaining a CSI-reference signal, CSI-RS, pattern and a CSI feedback size threshold, wherein the CSI-RS pattern and the CSI feedback size threshold are determined jointly;
receiving one or more pilot signals for at least one channel according to the CSI-RS pattern;
inputting a result of at least one measured channel on the one or more pilot signals into an ML model and obtaining CSI feedback as an output from the ML model;
transmitting, to the network node, the CSI feedback according to the CSI feedback size threshold.
